(19) United States
(12) Patent Application Publication
(10) Pub. No.: US 2011/0054123 A1
(43) Pub. Date: Mar. 3, 2011

(54) High Impact Polymers and Methods of Making and Using Same

(75) Inventors: Olga Khabashesku, Houston, TX (US); Billy J. Ellis, (US)

(73) Assignee: FINA TECHNOLOGY, INC., Houston, TX (US)

(21) Appl. No.: 12/548,240

(22) Filed: Aug. 26, 2009

(51) Int. Cl. C08F 255/00

(52) U.S. Cl. 525/386; 525/55; 525/387

(57) ABSTRACT

A method comprising contacting a grafting polymerization initiator with a composition comprising a vinylaromatic monomer and an elastomer under conditions suitable for the formation of a polymeric composition and forming the polymeric composition into an article wherein the article has an Izod impact strength of greater than 2.0 ft. lb./in. A method comprising contacting a grafting polymerization initiator with a vinylaromatic monomer and an elastomer under conditions suitable for the formation of a polymeric composition, wherein the grafting polymerization initiator comprises a peroxyketal.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

1. Technical Field

The present disclosure relates to polymerization initiators. More specifically, this disclosure relates to polymerization initiators for the production of vinylaromatic polymers.

2. Background

Elastomer-reinforced polymers of vinylaromatic compounds such as styrene, alpha-methylstyrene and ring-substituted styrene have found widespread commercial use. For example, elastomer-reinforced styrene polymers having discrete particles of cross-linked elastomer dispersed throughout the styrene polymer matrix can be useful for a range of applications including food packaging, office supplies, point-of-purchase signs and displays, housewares and consumer goods, building insulation, and cosmetics packaging. The incorporation of an elastomer into the styrene matrix results in improvements in a range of physical and mechanical properties (e.g., impact strength) and collectively these polymers are termed high-impact polystyrenes.

The utility of a particular HIPS depends on the polymer having some combination of mechanical, thermal, and/or physical properties that render the material suitable for a particular application. These properties are related in part to the extent of incorporation of the elastomeric material into the polymer matrix. Many factors during polymerization such as the polymerization conditions, monomer concentrations, and initiators can affect the properties of polymer. Initiators are relatively unstable molecules that function as a source of free radicals to enable polymerization. The nature of these initiators (e.g., stability, reactivity) may exert an effect on the properties of the resulting polymer. Thus, an ongoing need exists for polymerization initiators to produce HIPS having user-desired properties.

### BRIEF SUMMARY

Disclosed herein is a method comprising contacting a grafting polymerization initiator with a composition comprising a vinylaromatic monomer and an elastomer under conditions suitable for the formation of a polymeric composition having an Izod impact strength of greater than 2.0 ft. lb./in. The grafting polymerization initiator may comprise a gem-diperoxide, a peroxyketal, or combinations thereof. The grafting polymerization initiator may have the general formula:

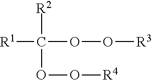

wherein R¹, R², R³, and R⁴ may be the same or different and may each independently comprise an alkyl group; an aryl group; derivatives thereof; or combinations thereof. The grafting polymerization initiator may comprise a trimethyl substituted cyclohexane. The peroxyketal may comprise 1,1-di(tert-butylperoxy)-3,3,5-trimethylcyclohexane. The vinylaromatic monomer may comprise styrene, alpha methyl styrene, ring substituted styrene, p-methylstyrene, disubstituted styrene, p-t-butyl styrene, unsubstituted styrene, or combinations thereof. The elastomer may comprise a conjugated diene monomer; 1,3-butadiene; 2-methyl-1,3-butadiene; 2-chloro-1,3 butadiene; 2-methyl-1,3-butadiene; 2-chloro-1,3-butadiene; aliphatic conjugated diene monomer; C₄ to C₉ diene; butadiene monomer, homopolymer of diene monomer; polybutadiene, or combinations thereof. The composition may further comprise a comonomer. The comonomer may comprise α-methylstyrene; halogenated styrenes; alkylated styrenes; acrylonitrile; esters of (meth)acrylic acid with alcohols having from 1 to 8 carbons; N-vinyl compounds; vinylcarbazole, maleic anhydride; compounds which contain two polymerizable double bonds; or combinations thereof. The contacting may be carried out via a first addition of initiator prior to phase inversion of the composition and a second addition of initiator after phase inversion of the composition. The polymeric composition may have a grafting percentage of greater than 80%. The polymeric composition may have a swell index of greater than 16%. The polymeric composition may have a weight average molecular weight of greater than 200 kiloDaltons. The polymeric composition may have a z average molecular weight of greater than 400 kiloDaltons. The method may further comprise forming the polymeric composition into an article having an Izod impact strength of greater than 2.0 ft.lb./in.

Also disclosed herein is a method comprising contacting a grafting polymerization initiator with a vinylaromatic monomer and an elastomer under conditions suitable for the formation of a polymeric composition, wherein the grafting polymerization initiator comprises a peroxyketal. The vinylaromatic monomer may comprise styrene and the elastomer may comprise polybutadiene. The peroxyketal may comprise 1,1-di(tert-butylperoxy)-3,3,5-trimethylcyclohexane. The polymeric composition may have a grafting percentage of greater than 80%.

Also disclosed herein is an article produced by any preceding method. The article may have an Izod impact strength of greater than 2.0 ft. lb./in.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a plot of solids percentage as a function of time for samples 1 and 2 from Example 1.

FIG. 2 is a plot of solids percentage as a function of time for samples 3-5 from Example 1.

FIG. 3 is a plot of molecular weight (Mw) and z-average molecular weight (Mz) for the samples from Example 3.

FIG. 4 is a plot of the percent solids as a function of reaction time for the samples from Example 5.

FIG. 5 shows transmission electron micrographs for the samples from Example 5.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are methods for producing high impact polymers exhibiting a high degree of grafting of an elastomeric material onto the polymeric backbone. In an embodiment, the method comprises contacting a monomer, an elastomer, and a grafting polymerization initiator (GPI) in a reaction zone under conditions suitable for the formation of a polymer having a high degree of grafted elastomeric material (HGEM). The extent of grafting will be described in more detail later herein. The monomer may be any compound capable of forming a polymeric composition that also comprises a grafted elastomer. The polymeric composition exhibits improved impact properties when compared to an otherwise similar polymeric composition lacking an elastomer. In an embodiment, the elastomer may comprise rubber, for example polybutadiene. In an embodiment, the monomer may be a vinylaromatic compound, alternatively the monomer may be styrene. Hereinafter, the disclosure will focus on the use of styrene as the monomer, however other monomers of the type described herein are also contemplated.

In an embodiment, a method for the production of the HGEM comprises contacting the GPI with a vinylaromatic monomer. In an embodiment, one or more styrene compounds are used as vinylaromatic monomers for the formation of the styrenic polymer and are included in same as repeating units. Styrene, also known as vinyl benzene, ethenylbenzene, and phenylethene is an organic compound represented by the chemical formula C₈H₈. Styrene is widely commercially available and as used herein the term styrene or styrenic monomer includes a variety of substituted styrenes (e.g., alpha-methyl styrene), ring-substituted styrenes such as p-methylstyrene, disubstituted styrenes such as p-t-butyl styrene as well as unsubstituted styrenes.

The styrenic monomer may be polymerized under reaction conditions suitable for the formation of a polymer. In an embodiment, the resulting HGEM may comprise a styrenic polymer (e.g., polystyrene), wherein the styrenic polymer may be a homopolymer or may optionally be a copolymer comprising one or more comonomers. In an embodiment, the styrenic polymer is present in an amount of from 1.0 to 99.9 weight percent by total weight of the HGEM (wt. %), alternatively from 5 wt. % to 99 wt. %, alternatively from 10 wt. % to 95 wt. %. In an embodiment, the styrenic polymer comprises the balance of the HGEM when other ingredients are accounted for.

In some embodiments, the styrenic polymer may further comprise a comonomer which when polymerized with the styrene forms a styrenic copolymer. Examples of such comonomers may include for example and without limitation α-methylstyrene; halogenated styrenes; alkylated styrenes; acrylonitrile; esters of (meth)acrylic acid with alcohols having from 1 to 8 carbons; N-vinyl compounds such as vinylcarbazole, maleic anhydride; compounds which contain two polymerizable double bonds such as for example and without limitation divinylbenzene or butanediol diacrylate; or combinations thereof. The comonomer may be present in an amount effective to impart one or more user-desired properties to the composition. Such effective amounts may be determined by one of ordinary skill in the art. For example, the comonomer may be incorporated into styrenic polymer in an amount ranging from 1 wt. % to 99.9 wt. % by weight of the styrenic polymer, alternatively from 1 wt. % to 90 wt. %, alternatively from 1 wt. % to 50 wt. %.

In an embodiment, a method for the production of the HGEM further comprises contacting the GPI, the vinylaromatic monomer, and an optional comonomer with an elastomer, also termed rubber. In such embodiments, the vinylaromatic monomer (e.g., styrene) and the elastomer may form a high impact polystyrene (HIPS). Such HIPS contain an elastomeric phase that is embedded in the styrenic polymer resulting in the composition having an increased impact resistance.

In an embodiment, the elastomer may be a conjugated diene monomer. Examples of suitable conjugated diene monomers include without limitation 1,3-butadiene, 2-methyl-1,3-butadiene, 2-chloro-1,3 butadiene, 2-methyl-1,3-butadiene, and 2-chloro-1,3-butadiene. Alternatively, the elastomer may be an aliphatic conjugated diene monomer. Without limitation, examples of suitable aliphatic conjugated diene monomers include C₄ to C₉ dienes such as butadiene monomers. Blends or copolymers of the diene monomers may also be used. Likewise, mixtures or blends of one or more elastomers may be used. In an embodiment, the elastomer comprises a homopolymer of a diene monomer, alternatively the elastomer comprises polybutadiene. In an embodiment, the HGEM comprises polybutadiene, alternatively a combination of high and/or medium and/or low cis polybutadiene. Herein the designation cis refers to the stereoconfiguration of the individual butadiene monomers wherein the main polymer chain is on the same side of the carbon-carbon double bond contained in the polybutadiene backbone as is shown in Structure I:

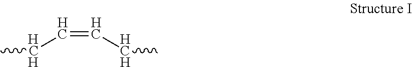

Elastomers (e.g., polybutadiene) suitable for use in this disclosure may be further characterized by a low vinyl content. Herein a low vinyl content refers to less than 5% of the material having terminal double bonds of the type represented in Structure II:

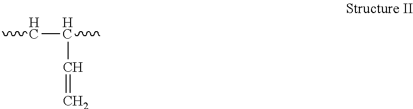

Such elastomers may be prepared by any means suitable for the preparation of high and/or medium and/or low cis content elastomers (e.g., polybutadiene). For example, the elastomers may be prepared through a solution process using a transition metal or alkyl metal catalyst.

Examples of elastomers suitable for use in this disclosure include without limitation DIENE-55 (D-55) and Firestone-645 (F-645), both of which are commercially available from Firestone. In an embodiment, an elastomer (e.g., D-55) has generally the physical properties set forth in Table 1.

TABLE 1

| | | | |
|---|---|---|---|
| Properties | Min. | Max | Test Method |

Raw Polymer Properties

| | | | |
|---|---|---|---|
| Mooney Viscosity | 39 | 49 | DIN 53 523 |
| UML 1 + 4 (100° C.)(MU) | | | |
| Volatile matter (wt %) | n/a | 0.5 | ASTM D 5668 |
| Total ash (wt %) | n/a | 0.5 | ASTM D 5667 |
| Organic acid (5) | n/a | 1.0 | ASTM D 5774 |

Cure Characteristics

| | | | |
|---|---|---|---|
| Minimum torque (dN, m) | 2.3 | 3.3 | ISO 6502 |
| Maximum Torque, S′ max. | 16.7 | 21.3 | ISO 6502 |
| (dN, m) | | | |
| tₛ1 (min) | 2.2 | 3.2 | ISO 6502 |
| t′50 (min) | 5.9 | 8.7 | ISO 6502 |
| Other Product Features | | Typical Value | |
| Cis 1,4-content | | 96 | |
| Specific Gravity | | 0.91 | |
| Stabilizer Type | | Non-staining | |

The elastomer may be present in amounts effective to produce one or more user-desired properties. Such effective amounts may be determined by one of ordinary skill in the art. For example, the elastomer may be incorporated into the HGEM in an amount ranging from 1 wt. % to 10 wt. % by total weight of the HGEM, alternatively from 2 wt. % to 8 wt. %, and alternatively from 3 wt. % to 5 wt. %.

In an embodiment, the GPI comprises a compound able to abstract allylic hydrogens and initiate vinyl polymerization. In an embodiment, the GPI comprises a gem-diperoxide, alternatively the GPI comprises a peroxyketal having a general formula as shown in Structure III.

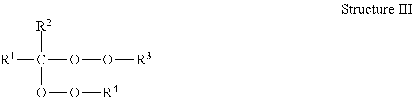

wherein R¹, R², R³, and R⁴ may be the same or different and may each independently comprise an alkyl group; an aryl group; derivatives thereof; or combinations thereof. In some embodiments, R¹ and R² may bond to form a 5-membered or 6-membered ring. In other embodiments, R³ and R⁴ may be a tert-butyl, tert-amyl, or combinations thereof.

In an embodiment, the GPI comprises a trimethyl substituted cyclohexane such as di(tert-butylperoxy)-3,3,5-trimethylcyclohexane (TMCH). TMCH is a chemical compound having the formula shown in Structure IV:

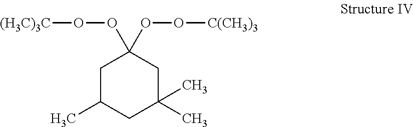

An example of a GPI (e.g., TMCH) suitable for use in this disclosure includes without limitation LUPEROX-231 (L-231), which is commercially available from Degussa. In an embodiment, a GPI (e.g., L-231) has generally the properties set forth in Table 2.

TABLE 2

| | L-231 |
|---|---|
| Properties | Typical Value |
| 1 hour Half Life, ° C. | 105 |
| Molecular Weight | 302 |
| Storage Temperature, ° C. | 25-30 |
| Assay, % | 92.0 min |
| Active Oxygen, % | 9.73 min |
| Form | Liquid |
| Diluent or Filler | None |
| Melting/Freezing Points, ° C. | −40 |
| Specific Gravity (g/ml ° C.) | 0.904 @ 25° C. |
| Refractive Index at ° C. | 1.4392 @ 21° C. |
| SADT ⁽¹⁾ ° C. Package Size | 66° 35 lbs cube |
| Flash Point ° F. (° C.) | 114° F. (46° C.) |
| (SETA Flash) ⁽²⁾ | |

⁽¹⁾ Self accelerating decomposition temperature, ASTM/UN Method
⁽²⁾ Flash point determined using a SETA tester.

Such GPIs may be provided as formulations in the absence of solvent, diluent, or filler and typically exhibit a storage life that is increased when compared to an otherwise similar composition further comprising a solvent, diluent, or filler.

In an embodiment, a method for the production of an HGEM comprises contacting a GPI with one or more vinylaromatic monomers (e.g., styrene), one or more optional comonomers, and one or more elastomers (e.g., polybutadiene, PB) under reaction conditions suitable for polymerization of the monomer.

In an embodiment, the GPI comprises TMCH, the vinylaromatic monomer comprises styrene and the elastomer comprises polybutadiene. In an embodiment, a method for the production of the HGEM comprises the dissolution of polybutadiene elastomer (PB) in styrene that is subsequently polymerized.

The effective amount of initiator for use in the production of the HGEM will depend on numerous factors (e.g., temperature, reaction time) and can be determined by one of ordinary skill in the art to meet the desired needs of the process.

A styrenic polymer produced using a GPI and elastomer of the type described herein may display an increased amount of grafting of the elastomeric material when compared to a low grafting polymerization initiator such as di(tert-butylperoxy-cyclohexane) whose chemical structure is shown as Structure V.

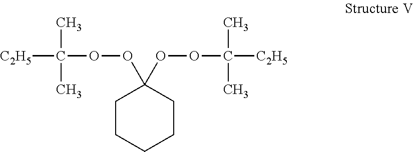

In an embodiment, the initiator is introduced to the reaction zone as a single aliquot or complement of material. The addition may occur by contacting of the initiator with the other components of the feed to form a reaction mixture that is subsequently polymerized.

In an alternative embodiment, the initiator may be introduced to the reaction zone via distributed additions. For example the initiator may be added in aliquots that are introduced to the reaction zone at different time points and/or different locations in the production of the HGEM. Various factors may influence the timing of addition of the GPI. In some embodiments, the initiator introduced to the reaction zones via distributed additions is the same at each addition; alternatively the initiator introduced to the reaction zones via distributed additions may differ in at least one addition. For example, during a polymerization process a low grafting polymerization initiator may be employed at some early stage in the reaction whereas a GPI of the type described herein may be introduced at a later stage in the reaction. The timing of the GPI addition may be calculated to increase the amount of GPI available to catalyze polymerization of the styrene following phase inversion. The timing for addition of the GPI may be adjusted by one of ordinary skill in the art to meet the needs of the process. For example, introduction of the initiator via staged additions may be carried out by the first addition of initiator prior to phase inversion of the composition and a second addition of initiator after phase inversion of the composition.

In an alternative embodiment, the initiator may be introduced to the reaction zone continuously using devices that allow for the controlled addition of the material at locations in the reaction zone or process equipment of the type described herein. Devices suitable for the continuous controlled addition of a material (e.g., initiator) include for example and without limitation metering systems such as mass flow controllers.

In an embodiment, the total amount of initiator introduced to a reactor by distributed addition may be less than the total amount of initiator utilized in a conventional production process (i.e., single addition) to produce a comparable polymerization rate. For example, the amount of initiator introduced to the reactor may be reduced by greater than 5%, alternatively greater than 8%, alternatively greater than 10%, when compared to a conventional production process (i.e., single addition) to produce a comparable polymerization rate.

In an embodiment, the polymerization reaction to form the HGEM may be carried out in a solution or mass polymerization process. Mass polymerization, also known as bulk polymerization refers to the polymerization of a monomer in the absence of any medium other than the monomer and a catalyst or polymerization initiator. Solution polymerization refers to a polymerization process in which the monomers and polymerization initiators are dissolved in a non-monomeric liquid solvent at the beginning of the polymerization reaction. The liquid is usually also a solvent for the resulting polymer or copolymer.

The polymerization process can be either batch or continuous. In an embodiment, the polymerization reaction may be carried out using a continuous production process in a polymerization apparatus comprising a single reactor or a plurality of reactors. For example, the polymeric composition can be prepared using an upflow reactor. Reactors and conditions for the production of a polymeric composition are disclosed in U.S. Pat. No. 4,777,210, which is incorporated by reference herein in its entirety.

In yet another embodiment, the polymerization reaction may be carried out in a plurality of reactors with each reactor having an optimum temperature range. For example, the polymerization reaction may be carried out in a reactor system employing a first and second polymerization reactor that are either continuously stirred tank reactors (CSTR) or plug-flow reactors. In an embodiment, a polymerization reactor for the production of an HGEM of the type disclosed herein comprising a plurality of reactors may have a first reactor (e.g., a CSTR), also known as the prepolymerization reactor, and a second reactor (e.g., CSTR or plug flow).

The product effluent from the first reactor may be referred to herein as the prepolymer. When the prepolymer reaches the desired conversion, it may be passed through a heating device into a second reactor for further polymerization. The polymerized product effluent from the second reactor may be further processed and is described in detail in the literature. Upon completion of the polymerization reaction, an HGEM is recovered from the second reactor and subsequently processed, for example devolatized, pelletized, etc.

In an embodiment, the HGEM may also comprise additives as deemed necessary to impart desired physical properties, such as, increased gloss or color. Examples of additives include without limitation stabilizers, chain transfer agents, talc, antioxidants, UV stabilizers, lubricants, plasticizers, ultra-violet screening agents, oxidants, anti-oxidants, anti-static agents, ultraviolet light absorbents, fire retardants, processing oils, mold release agents, coloring agents, pigments/dyes, fillers, and the like. The aforementioned additives may be used either singularly or in combination to form various formulations of the composition. For example, stabilizers or stabilization agents may be employed to help protect the polymeric composition from degradation due to exposure to excessive temperatures and/or ultraviolet light. The additives may be added after recovery of the HGEM, for example during compounding such as pelletization. Alternatively or additionally to the inclusion of such additives in the styrenic polymer component of the HGEM, such additives may be added during formation of the HGEM or to one or more other components of the HGEM.

These additives may be included in amounts effective to impart the desired properties. Effective additive amounts and processes for inclusion of these additives to polymeric compositions are known to one skilled in the art. For example, the additives may be present in an amount of from 0.1 wt. % to 50 wt. %, alternatively from 1 wt. % to 40 wt. %, alternatively from 2 wt. % to 30 wt. % based on the total weight of the composition.

In an embodiment, a styrenic polymer prepared as described in this disclosure (e.g., HGEM) may have a melt flow rate as determined in accordance with ASTM D-1238 of from 1.7 g/10 min. to 15 g/10 min., alternatively from 2.5 g/10 min. to 9.2 g/10 min., and alternatively from 2.6 g/10 min. to 3.4 g/10 min.; a tensile modulus as determined in accordance with ASTM D-638 of from 1.92×10⁵ psi to 2.68×10⁵ psi, alternatively from 2.22×10⁵ psi to 2.32×10⁵ psi, and alternatively from 2.15×10⁵ psi to 2.22×10⁵ psi; a tensile strength at yield as determined in accordance with ASTM D-638 of from 2400 psi to 5000 psi, alternatively from 2400 psi to 4900 psi, and alternatively from 2400 psi to 4100 psi; an elongation at yield as determined in accordance with ASTM D-638 of from 40% to 70%, alternatively from 40% to 60%, alternatively from 45% to 50%; a tensile strength at break as determined in accordance with ASTM D-638 of from 2800 psi to 4800 psi, alternatively from 3000 psi to 4500 psi, alternatively from 3300 psi to 3600 psi; a flexural modulus as determined in accordance with ASTM D-790 of from 2.07×10⁵ psi to 3.7×10⁵ psi, alternatively from 2.4×10⁵ psi to 3.7×10⁵ psi, alternatively from 2.5×10⁵ psi to 3.5×10⁵ psi; a heat distortion as determined in accordance with ASTM D-648 of from 190° F. to 206° F., alternatively from 195° F. to 206° F., alternatively from 201° F. to 206° F.; a Vicat softening as determined in accordance with ASTM D-1525 of from 200° F. to 220° F., alternatively from 200° F. to 210° F., alternatively from 202° F. to 210° F.

In an embodiment, the HGEM produced using a GPI of the type disclosed herein may have a grafting percentage of greater than 80%, alternatively greater than 90%, alternatively from greater than 100%. The grafting percentage (i.e., % rubber) may be measured using any suitable technique known in the art such as the Iodine Monochloride (I—Cl) titration method.

In an embodiment, the HGEM produced using a GPI of the type disclosed herein may have a swell index of greater than 16%, alternatively greater than 20%, alternatively greater than 25%. Swell index can be used to measure the extent of interfacial bonding (crosslinking) between polystyrene and elastomer (i.e., polybutadiene). Swell index may be determined by taking a ratio between mass of moist gel to mass of dry gel, as determined in accordance with ASTM D3616.

In an embodiment, the HGEM may have a weight average molecular weight (Mw) of greater than 200 kiloDaltons, alternatively greater than 270 kiloDaltons, alternatively greater than 290 kiloDaltons. The weight-average molecular weight Mw is given by equation 1:

Mw=ΣwxMx (1)

where wx is the weight-fraction of molecules whose weight is Mx. The Mw is related to polymer strength properties such as tensile strength and impact resistance.

In an embodiment, the HGEM may have a z average molecular weight (Mz) of greater than 400 kiloDaltons, alternatively greater than 450 kiloDaltons, alternatively greater than 490 kiloDaltoms. The z-average molecular weight Mw is given by equation 2:

Mz=ΣwxMx²/ΣwxMx (2)

where wx is the weight-fraction of molecules whose weight is Mx. Mz is related to polymer ductile properties such as elongation and flexibility.

The HGEMs produced using a GPI of the type disclosed herein may be converted to end-use articles by any suitable method. In an embodiment, this conversion is a plastics shaping process such as blowmoulding, extrusion, injection blowmoulding, injection stretch blowmoulding, thermoforming, and the like. Examples of end use articles into which the polymeric blend may be formed include food packaging, office supplies, plastic lumber, replacement lumber, patio decking, structural supports, laminate flooring compositions, polymeric foam substrate; decorative surfaces (i.e., crown molding, etc) weatherable outdoor materials, point-of-purchase signs and displays, housewares and consumer goods, building insulation, cosmetics packaging, outdoor replacement materials, lids and containers (i.e., for deli, fruit, candies and cookies), appliances, utensils, electronic parts, automotive parts, enclosures, protective head gear, reusable paintballs, toys (e.g., LEGO bricks), musical instruments, golf club heads, piping, business machines and telephone components, shower heads, door handles, faucet handles, wheel covers, automotive front grilles, and so forth.

In an embodiment, an article constructed from an HGEM produced using a GPI of the type disclosed herein may exhibit an Izod impact strength greater than 2.0 ft-lb/in, alternatively greater than 3.0 ft-lb/in, alternatively greater than 5.0 ft-lb/in, as determined in accordance with ASTM D256.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

Polymerization rates for the production of crystal grade polystyrene using a GPI of the type disclosed herein was compared to the rates obtained with a low grafting polymerization initiator. In the first comparison, two polystyrene samples were prepared using two different initiators. Sample 1 was prepared using 128 parts per million (ppm) of TMCH initiator at a 92% purity level, and styrene monomer. The sample was batch polymerized using the following temperature profile: 110° C. for two hours, 130° C. for one hour, and 150° C. for one hour. Sample 2 was prepared using the same styrene feed and procedure as Sample 1 but with 125 ppm of L-233 initiator. L-233 is an ethyl 3,3-di(t-butylperoxy)-butyrate which is commercially available from Arkema.

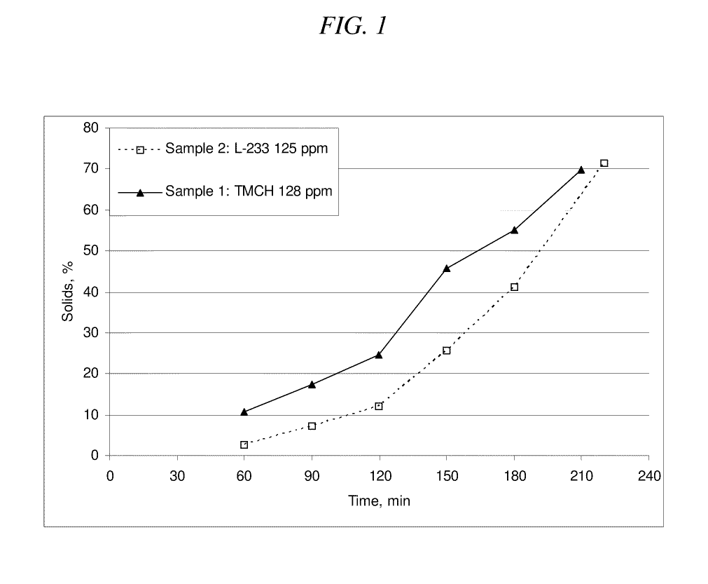

FIG. 1 shows the polymerization rate as measured by the solids percentage (solids %, the amount of solids produced) as a function of the reaction time for formation of the polystyrene homopolymer in the absence of an elastomer. The solids percentage values were obtained by removing aliquots of the reaction solution (Ms) from the reactor and determining the weight of the sample after evaporating the solvent (Me) according to the following equation: solids %=100(Ms−Me)/Ms. Referring to FIG. 1, higher polymerization rates were observed for Sample 1 containing a GPI as evidenced by a higher % solids at a given reaction time when compared to Sample 2 which did not contain a GPI. The difference in the polymerization rates was largest during the first 120 minutes of polymerization at 110° C. and between 120 and 180 minutes at 130° C. The results demonstrate the use of a high grafting initiator (i.e., a GPI as described herein) resulted in an increased polymerization rate.

In the second comparison, three HGEM samples, designated Samples 3-5, were prepared by batch polymerizing solutions comprising 4% D-55 polybutadiene and 96% styrene monomer. The batch polymerizations were carried out at a temperature profile of 110° C. for two hours, 130° C. for one hour, and 150° C. for one hour. Sample 3 was prepared using 140 ppm of TMCH initiator at a 92% purity level, Sample 4 was prepared using 170 ppm of L-233 initiator, and Sample 5 was prepared using 170 ppm of LUPEROX 531 M80 initiator (L-531) as a 80% solution in mineral oil. L-531 is 1,1-Di(t-amylperoxy)cyclohexane which is a peroxide initiator commercially available from Arkema.

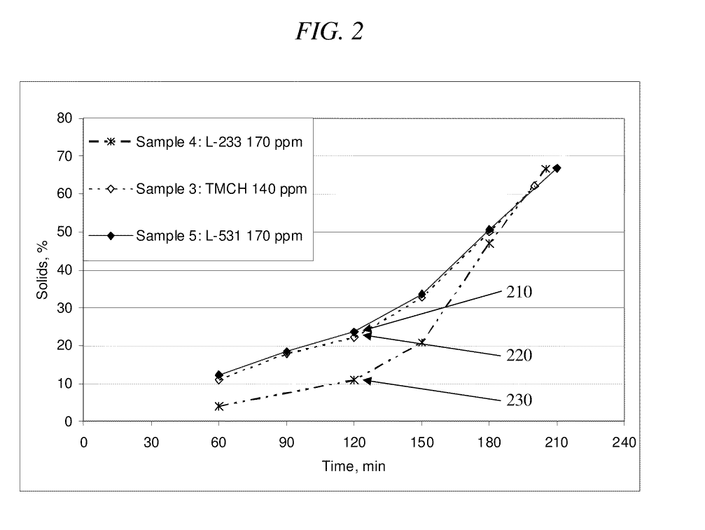

FIG. 2 shows the polymerization rate as measured by the solids percentage as a function of reaction time for samples 3-5. Referring to FIG. 2, the final solids percentage of Sample 3 was similar to that observed in Samples 4 and 5. This was an unexpected result as the initiator concentration used in Sample 3 was reduced when compared to the concentration used in the Samples 4 and 5; 140 ppm, 170 ppm and 170 ppm respectively. This result indicates that TMCH is a more active polymerization initiator for the production of a high impact polymer when compared to L-233 and L-531 providing similar conversions as indicated by similar final solids percentage at lower initiator loadings.

### Example 2

The effect of initiator type on the Izod impact strength of a HGEM was investigated. All samples contained styrene monomer at approximately 96 wt. % and 4 wt. % D-55 rubber. Four samples, designated Samples 6-9, were prepared using TMCH initiator of 92% purity level at loadings of 200 ppm, 170 ppm, 140 ppm, and 135 ppm respectively. Three samples, designated Samples 10-12, were prepared using L-531 initiator as an 80% solution in mineral oil at loadings of 200 ppm, 170 ppm, and 140 ppm respectively. Sample 13 was prepared using L-233 initiator at a loading of 170 ppm. All samples (Samples 6-13) were polymerized as described in Example 1. Various physical properties as set forth in Table 3 were determined in accordance with the appropriate methodologies previously described herein and the results are tabulated in Table 3.

TABLE 3

| | Initiator, | Loadings | | | Product | | Gel-to- | Izod | |
|---|---|---|---|---|---|---|---|---|---|
| Sample | ppm | (ppm) | % Gels | Swell Index | % Elastomer | % Grafting | Elastomer | (ft. lb/in) | Izod Range |
| 6 | TMCH | 200 | 12.8 | 17.1 | 5.83 | 119.1 | 2.2 | 2.08 | 0.42 |
| 7 | TMCH | 170 | 13.8 | 25.8 | 6.05 | 127.3 | 2.3 | 5.10 | 1.57 |
| 8 | TMCH | 140 | 15.5 | 16.5 | 6.44 | 141.0 | 2.4 | 3.23 | 0.40 |
| 9 | TMCH | 135 | 15.3 | 16.0 | 6.34 | 140.5 | 2.4 | n/a | n/a |
| 10 | L-531 | 200 | 11.1 | 16.5 | 5.76 | 93.1 | 1.9 | 3.86 | 1.38 |
| 11 | L-531 | 170 | 12.4 | 15.4 | 5.98 | 107.1 | 2.1 | 4.14 | 1.48 |
| 12 | L-531 | 140 | 12.7 | 15.3 | 6.18 | 105.2 | 2.1 | 3.77 | 0.82 |
| 13 | L-233 | 170 | 17.1 | 14.5 | 5.67 | 200.9 | 3.0 | n/a | n/a |

The results demonstrate that samples prepared with the TMCH initiator resulted in higher gel percentage and gel to elastomer ratio than samples prepared using L-531 but lower than samples prepared using L-233 at similar initiator loadings. Malvern scans for Rubber Particle Size (RPS) for TMCH initiated HIPS samples showed the presence of very small particles <1 micron: d(0.1) for TMCH initiated samples was 0.80-0.90 micron. The presence of particles less than 1 micron usually leads to lower gels numbers because small particles tend to form watery gels that are lost during gel separation by decanting. Further, samples prepared with the TMCH initiator exhibited a higher swell index gel percentage and higher elastomer utilization than samples prepared with either L-531 or L-233 at similar initiator loadings. The high gel-to-rubber ratio is characteristic of rubber particles with thin walls and a large number of polystyrene occlusions indicating that the compositions of the present disclosure have an increased rubber distribution. The increased rubber distribution contributes to the impact resistance of the composition.

By comparing Samples 6-8 and Samples 10-12, samples prepared with the TMCH initiator displayed a higher grafting percentage when compared to samples prepared with L-531. However, the sample prepared with the L-233 initiator (Sample 13) displayed the highest grafting percentage of the initiators investigated at a loading of 170 ppm. At loadings higher than 170 ppm, both TMCH and L-531 showed overgrafting. Overgrafting may adversely affect properties such as impact strength due to the formation of a large number of small particles.

The Izod impact strength of the samples was determined in accordance with the previously referenced ASTM method. Specifically, devolatalized samples were first compression molded into sheet that were, cut up for insertion into a differential scanning microcalorimeter (DSM) heating chamber. Compression molding was conducted at 190° C. with a pre-heat time of 3 minutes and a high compression time of 2 minutes. The DSM injection molder sample heating chamber was set at 230° C. and a mold temperature of 60° C. was utilized. Maximum injection pressure (6.5 bar) was used to inject the molten polymer into the mold cavity with a hold time of 30 seconds. Referring to Table 3, higher Izod values were obtained for all samples (Samples 6-8 and 10-12) when compared to the literature values for other commercially available high impact polystyrenes such as TOTAL 740, 819E, and 825, which have Izod impact strength values of 1.90, 2.20, and 2.00 ft. lb/in respectively. In particular, samples prepared using TMCH showed unexpectedly high Izod impact strengths with values as high as 5.15 ft. lb/in.

The polymer samples prepared using the various initiators show scattering of hod numbers from test to test resulting in wide ranges of Izod, as shown in Table 3. Referring to FIG. 2, the use of both TMCH (Sample 3) and L-531 initiators (Sample 5) led to higher polymerization rate during the first hour of polymerization process at the inversion points 210 and 220 respectively (˜10% solids), when compared to the inversion point 230 of L-233 initiator (˜2.5% solids). The higher polymerization rates at the beginning lead to a rapid increase in solution viscosity resulting in a heterogeneous solution, which could not be sufficiently homogenized by mixing.

### Example 3

The elastomer particle size (RPS) of samples prepared using the TMCH initiator was investigated. The RPS for Samples 6-9 from Example 2 was measured using a standard laser light scattering device which was a MASTERSIZER 2000 integrated system for particle sizing commercially available from Malvern Instruments. The results demonstrate that these samples had a d(0.1) of 0.8-0.9 microns. D (0.1) is a measure of the number of particles having a particle size less than 1 micron.

### Example 4

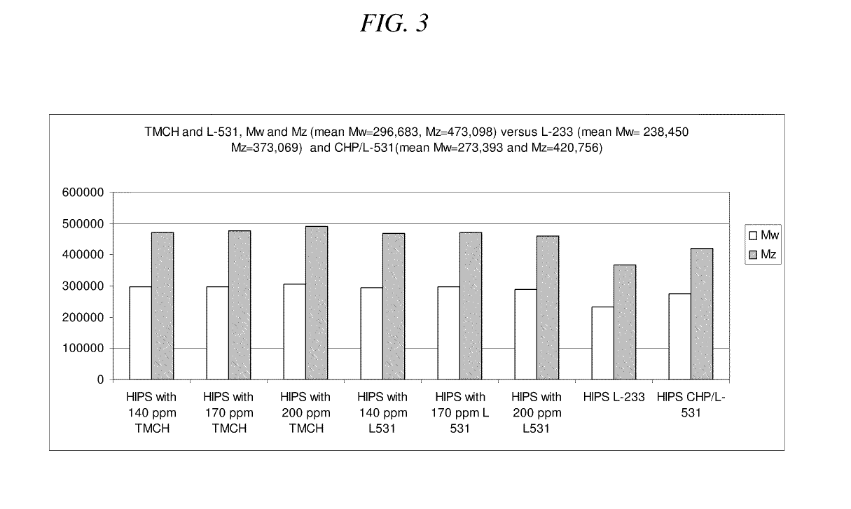

The effect of the initiator on the molecular weight of HGEMs prepared using TMCH, L-531, and L-233 initiators was investigated. Three samples, designated Samples 14-16, were prepared using a TMCH initiator at a 92% purity level at loadings of 140 ppm, 170 ppm, and 200 ppm respectively. Three samples, designated Samples 17-19, were prepared using L-531 initiator as an 80% solution in mineral oil at loadings of 140 ppm, 170 ppm, and 200 ppm respectively Sample 20 was prepared using L-233 initiator at a loading of 150 ppm. Sample 21 was prepared using a mixture comprising cumene hydroperoxide (CHP) at a loading of 120 ppm and L-531 at a loading of 70 ppm. All samples further contained styrene and polybutadiene and were polymerized as described in Example 1. The weight average (Mw) and zaverage molecular weight (Mz) of the resulting polymer were determined for these samples. The results are tabulated in Table 4 and depicted in FIG. 3.

TABLE 4

| | Catalyst, | Loadings |
|---|---|---|
| Sample | ppm | (ppm) |
| 14 | TMCH | 140 |
| 15 | TMCH | 170 |
| 16 | TMCH | 200 |
| 17 | L-531 | 140 |
| 18 | L-531 | 170 |
| 19 | L-531 | 200 |
| 20 | L-233 | 150 |
| 21 | CHP/L-531 | 120/70 |

The results demonstrate both the Mw and Mz of polymer samples prepared using TMCH and L-531 were higher than samples prepared using L-233 or the CHP/L-531 mixture.

### Example 5

The effect of introducing the initiator via a distributed addition was investigated. Specifically, the L-233 initiator was added in two additions to a styrene/polybutadiene feed. In the first addition, 130 ppm of L-233 was added before polymerization to the feed and 70 ppm was added at 120 minutes reaction time. The resultant polymeric composition was designated Sample 22. Samples 23-25 were prepared using a similar styrene/polybutadiene feed however; the initiator used was TMCH which was introduced to the reaction zone in two additions. For Sample 23, 77 ppm was added before polymerization and 39 ppm was added at 120 minutes reaction time. For Sample 24, 50 ppm was added before polymerization and 65 ppm was added at 120 minutes reaction time. For Sample 25, 70 ppm was added before polymerization and 70 ppm was added at 90 minutes reaction time. All samples were polymerized as described in Example 1. The initiator, amounts of initiator added, the order of addition, and the mechanical properties of the resulting polymer samples are tabulated in Table 5.

TABLE 5

| Sample | 22 | 23 | 24 | 25 |
|---|---|---|---|---|
| Initiator type | L-233 | TMCH | TMCH | TMCH |
| Initiator amount, ppm | 200 | 116 | 115 | 140 |
| Order of init. addition | 130 + 70 | 77 + 39 | 50 + 65 | 70 + 70 |
| Izod, psi | 2.22 | 3.25 | 2.75 | 2.78 |
| Notched, STDEV | 0.3 | 0.2 | 0.2 | 0.6 |
| Tensile Modulus × 10⁵, | 3.08 | 3.64 | 3.24 | 3.4 |
| psi | | | | |
| Tensile Strength @ | 5739 | 6134 | 5709 | 5014 |
| Yield psi | | | | |
| Tensile Strength @ | 5104 | 5810 | 5342 | 5354 |
| Break psi | | | | |

The results demonstrate that the values obtained for the Izod impact (notched), tensile modulus, and tensile strength at break for the samples prepared by distributed addition of the TMCH initiator (Samples 23-25) are higher than those obtained for the sample prepared with distributed addition of L-233 (Sample 22). The tensile strength at yield for the samples prepared with distributed addition of the TMCH initiator (Samples 23-25) was within 15% of the value obtained with the L-233 initiator (Sample 22). Sample 23 demonstrated higher Izod characteristic for higher rubber grafting in the polymer (HIPS) and was obtained with less total amount of initiator than that used for obtaining samples 24 and 25, which makes this type of staged addition with more initiator added at the beginning of polymerization a more cost-efficient way to make HIPS. Grafting occurs early in the polymerization process; so adding more initiator at the beginning of the polymerization causes higher grafting levels. However, initiator gets consumed during polymerization with the rate depending on the half-life of the initiator. The second portion of the initiator was added when grafting and formation of rubber particles had already occurred and serves to boost the conversion. These results suggest that a first high-grafting initiator may be used in the first portion of the initiator loading, and a second lower grafting ability initiator used later in the polymerization process to increase conversion.

### Example 6

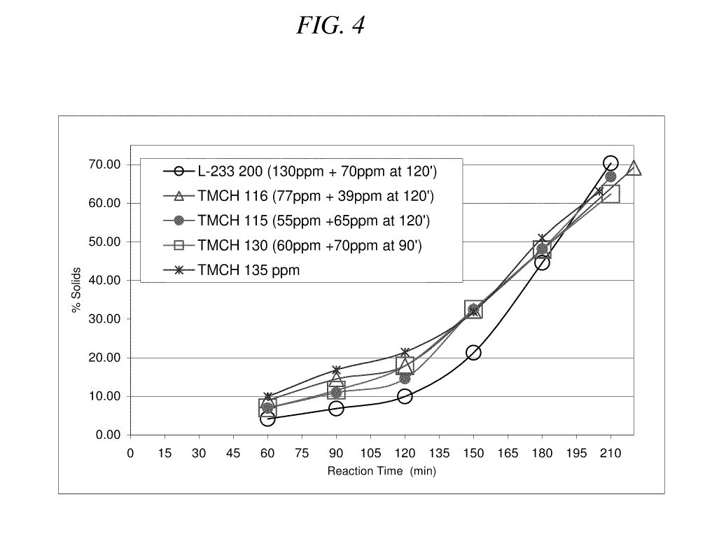

The effect of the GPI concentration on the polymerization reaction and polymer product was investigated. Laboratory batch polymerizations were carried out with the levels of TMCH loading indicated in FIG. 4 and compared with runs initiated with 200 ppm of L-233. The standard temperature profile: 110° C. for two hours, 130° C. for one hour and 150° C. for one hour was used for both crystal and HIPS polymerizations. Referring to FIG. 4, TMCH tended to cause inversion early in polymerization process: specifically, the solids reached ˜10% (2.5×4% initial butyl rubber concentration, inversion point) at 60 min into polymerization process with TMCH and at 120 min with L-233. Various mechanical properties of the samples were assayed and the results are presented in Table 6.

TABLE 6

| | | Sample | | | | |
|---|---|---|---|---|---|---|
| | | L-233 | | | | |
| | | (130 + 70) | TMCH | TMCH | TMCH | |
| | | ppm | (77 + 39) ppm | (60 + 70) ppm | (55 + 65) ppm | TMCH 140 ppm |
| | | sample # | | | | |
| | | 1161-81-1 | 1161-81-2 | 1161-81-4 | 1161-81-3 | 1161-80-6 |
| IZOD | Break Type- | Complete | Hinged | Hinged | Hinged Break | Partial Break |
| | Notched | Break | Break | Break | | |
| | Izod Impact- | 2.22 | 3.25 | 2.78 | 2.75 | 3.32 |
| | Notched (ft. | | | | | |
| | lb/in.) | | | | | |
| | Notched | 0.3 | 0.2 | 0.6 | 0.2 | 0.4 |
| | STDEV | | | | | |
| PS TENSILE | Tensile | 3.08E+05 | 3.64E+05 | 3.40E+05 | 3.24E+05 | |
| | Modulus (psi) | | | | | |
| | Tensile | 5739 | 6134 | 6014 | 5709 | |
| | Strength @ | | | | | |
| | Yield (psi) | | | | | |
| | Tensile | 5104 | 5810 | 5354 | 5342 | |
| | Strength @ | | | | | |
| | Break (psi) | | | | | |

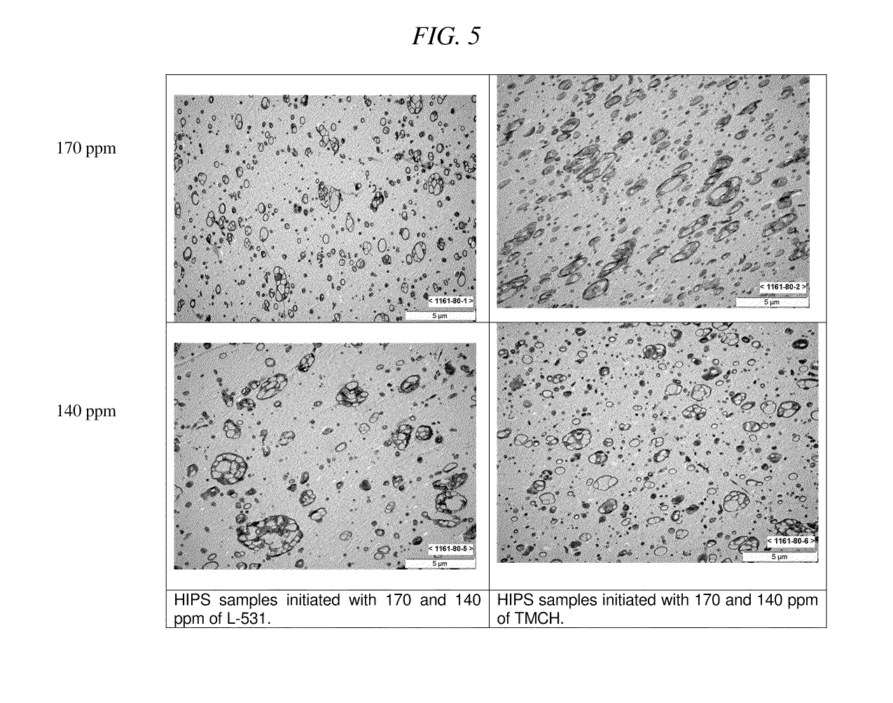

FIG. 5 shows transmission electron micrograph (TEM) images of HIPS samples initiated with 170 ppm or 140 ppm of TMCH or L-531 as indicated. TEM images of HIPS samples obtained with perketal initiators showed mixed morphology: small core-shell type rubber particles are mixed with salami-type particles. The proportion of small particles varied from sample to sample. However, while the patterns of rubber particles differ slightly, the ligament length, the distance between rubber particles, is rather small for all samples.

While various embodiments have been shown and described, modifications thereof can be made by one skilled in the art without departing from the spirit and teachings of the disclosure. The embodiments described herein are exemplary only, and are not intended to be limiting. Many variations and modifications of the subject matter disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method comprising:
contacting a grafting polymerization initiator with a composition comprising a vinylaromatic monomer and an elastomer under conditions suitable for the formation of a polymeric composition; and
forming the polymeric composition into an article wherein the article has an Izod impact strength of greater than 2.0 ft. lb./in.

2. The method of claim 1 wherein the grafting polymerization initiator comprises a gem-diperoxide, a peroxyketal, or combinations thereof.

3. The method of claim 1 wherein the grafting polymerization initiator has the general formula: 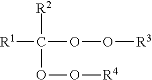
wherein R¹, R², R³, and R⁴ may be the same or different and may each independently comprise an alkyl group; an aryl group; derivatives thereof; or combinations thereof.

4. The method of claim 1 wherein the grafting polymerization initiator comprises a trimethyl substituted cyclohexane.

5. The method of claim 2 wherein the peroxyketal comprises 1,1-di(tert-butylperoxy)-3,3,5-trimethylcyclohexane.

6. The method of claim 1 wherein the vinylaromatic monomer comprises styrene, alpha methyl styrene, ring substituted styrene, p-methylstyrene, disubstituted styrene, p-t-butyl styrene, unsubstituted styrene, or combinations thereof.

7. The method of claim 1 wherein the elastomer comprises conjugated diene monomer; 1,3-butadiene; 2-methyl-1,3-butadiene; 2-chloro-1,3 butadiene; 2-methyl-1,3-butadiene; 2-chloro-1,3-butadiene; aliphatic conjugated diene monomer; C₄ to C₉ diene; butadiene monomer, homopolymer of diene monomer; polybutadiene, or combinations thereof.

8. The method of claim 1 wherein the composition further comprises a comonomer.

9. The method of claim 8 wherein the comonomer comprises α-methylstyrene; halogenated styrenes; alkylated styrenes; acrylonitrile; esters of (meth)acrylic acid with alcohols having from 1 to 8 carbons; N-vinyl compounds; vinylcarbazole, maleic anhydride; compounds which contain two polymerizable double bonds; or combinations thereof.

10. The method of claim 1 wherein the contacting is carried out via a first addition of initiator prior to phase inversion of the composition and a second addition of initiator after phase inversion of the composition.

11. The method of claim 1 wherein the polymeric composition has a grafting percentage of greater than 80%.

12. The method of claim 1 wherein the polymeric composition has a swell index of greater than 16%.

13. The method of claim 1 wherein the polymeric composition has a weight average molecular weight of greater than 200 kiloDaltons.

14. The method of claim 1 wherein the polymeric composition has a z average molecular weight of greater than 400 kiloDaltons.

15. A method comprising contacting a grafting polymerization initiator with a vinylaromatic monomer and an elastomer under conditions suitable for the formation of a polymeric composition, wherein the grafting polymerization initiator comprises a peroxyketal.

16. The method of claim 15 wherein the vinylaromatic monomer comprises styrene and the elastomer comprises polybutadiene.

17. The method of claim 15 wherein the peroxyketal comprises 1,1-di(tert-butylperoxy)-3,3,5-trimethylcyclohexane.

18. The method of claim 15 wherein the polymeric composition has a grafting percentage of greater than 80%.

19. An article produced by the method of claim 15.

20. The article of claim 19 having an Izod impact strength of greater than 2.0 ft. lb./in.
